(19) United States
(12) Patent Application Publication
(10) Pub. No.: US 2019/0228765 A1
(43) Pub. Date: Jul. 25, 2019

(54) SPEECH ANALYSIS APPARATUS, SPEECH ANALYSIS SYSTEM, AND NON-TRANSITORY COMPUTER READABLE MEDIUM

(71) Applicant: FUJI XEROX CO., LTD., Tokyo (JP)

(72) Inventor: Xuan LUO, Kanagawa (JP)

(73) Assignee: FUJI XEROX CO., LTD., Tokyo (JP)

(21) Appl. No.: 16/240,797

(22) Filed: Jan. 7, 2019

(30) Foreign Application Priority Data
Jan. 19, 2018 (JP) 2018-007349

(51) Int. Cl. G10L 15/18; G10L 15/04; G10L 15/19

(52) U.S. Cl. CPC G10L 15/1807; G10L 15/19; G10L 15/04; G10L 15/1822

(57) ABSTRACT

There is provided a speech analysis apparatus that operates in combination with a speech acquisition apparatus. The speech analysis apparatus includes a segmenting unit that segments a speech signal representing an utterance acquired by the speech acquisition apparatus into sections, each of the sections corresponding to a word, a first calculating unit that calculates a stress level of each of the sections into which the speech signal is segmented by the segmenting unit, a speech recognition unit that performs speech recognition and recognizes a word corresponding to each of the sections that have been subjected to the speech recognition, a second calculating unit that uses a weight, the weight being predetermined for each of the words recognized by the speech recognition unit regarding at least one of multiple topics, and the stress level of a section to which each of the words recognized by the speech recognition unit corresponds, the stress level being calculated by the first calculating unit, and that calculates an index for the at least one of multiple topics, and a determining unit that identifies a topic of the utterance among the multiple topics in accordance with the indexes calculated by the second calculating unit.

### CROSS-REFERENCE TO RELATED APPLICATIONS

This application is based on and claims priority under 35 USC 119 from Japanese Patent Application No. 2018-007349 filed Jan. 19, 2018.

### BACKGROUND

### (i) Technical Field

The present disclosure relates to a speech analysis apparatus, a speech analysis system, and a non-transitory computer readable medium.

### (ii) Related Art

Techniques to analyze an utterance and extract a major portion from the utterance are known. For example, Japanese Patent No. 5875504 discloses a technique to automatically extract a section of an utterance that corresponds to a stressed portion from a vocalized utterance. Japanese Patent No. 4458888 discloses a technique to distinguish a topic discussed during each predetermined period in a conference in accordance with the number of topic names included in sentences spoken in each of the predetermined periods. Japanese Patent No. 5386692 discloses a technique to recognize a topic in accordance with a pattern of appearance frequency of each of a plurality of spoken words.

### SUMMARY

The technique disclosed in Japanese Patent No. 5875504 extracts only a stressed portion in an utterance and does not infer the topic of the utterance. When the topic of an utterance is inferred from only the number of appearances or the appearance frequency of each word relating to the topic of the utterance as in Japanese Patent No. 4458888 or Japanese Patent No. 5386692, the topic is sometimes incorrectly inferred.

Aspects of a non-limiting embodiment of the present disclosure relate to accurately determining the topic of an utterance.

Aspects of a certain non-limiting embodiment of the present disclosure overcome the above disadvantages and/or other disadvantages not described above. However, aspects of the non-limiting embodiment are not required to overcome the disadvantages described above, and aspects of the non-limiting embodiment of the present disclosure may not overcome any of the disadvantages described above.

According to an aspect of the present disclosure, there is provided a speech analysis apparatus that operates in combination with a speech acquisition apparatus. The speech analysis apparatus includes a segmenting unit that segments a speech signal representing an utterance acquired by the speech acquisition apparatus into sections, each of the sections corresponding to a word, a first calculating unit that calculates a stress level of each of the sections into which the speech signal is segmented by the segmenting unit, a speech recognition unit that performs speech recognition and recognizes a word corresponding to each of the sections that have been subjected to the speech recognition, a second calculating unit that uses a weight, the weight being predetermined for each of the words recognized by the speech recognition unit regarding at least one of a plurality of topics, and the stress level of a section to which each of the words recognized by the speech recognition unit corresponds, the stress level being calculated by the first calculating unit, and that calculates an index for the at least one of the plurality of topics, and a determining unit that identifies a topic of the utterance among the plurality of topics in accordance with the indexes calculated by the second calculating unit.

### BRIEF DESCRIPTION OF THE DRAWINGS

An exemplary embodiment of the present disclosure will be described in detail based on the following figures, wherein:

FIG. 1 depicts an example of a configuration of a speech analysis system according to an exemplary embodiment;

FIG. 2 depicts an example of a hardware configuration of a speech analysis apparatus;

FIG. 3 depicts an example of a functional configuration of the speech analysis apparatus;

FIG. 4 is a flowchart depicting example processing of generating a piece of setting information;

FIG. 5 illustrates an example of a speech signal;

FIG. 6 illustrates an example of a piece of setting information;

FIG. 7 is a flowchart depicting an example of topic inference processing;

FIG. 8 illustrates an example of a speech signal;

FIG. 9 illustrates an example of stress levels;

FIG. 10 illustrates an example of a relation table; and

FIG. 11 illustrates an example presentation of topic information.

### DETAILED DESCRIPTION

### 1. Configuration

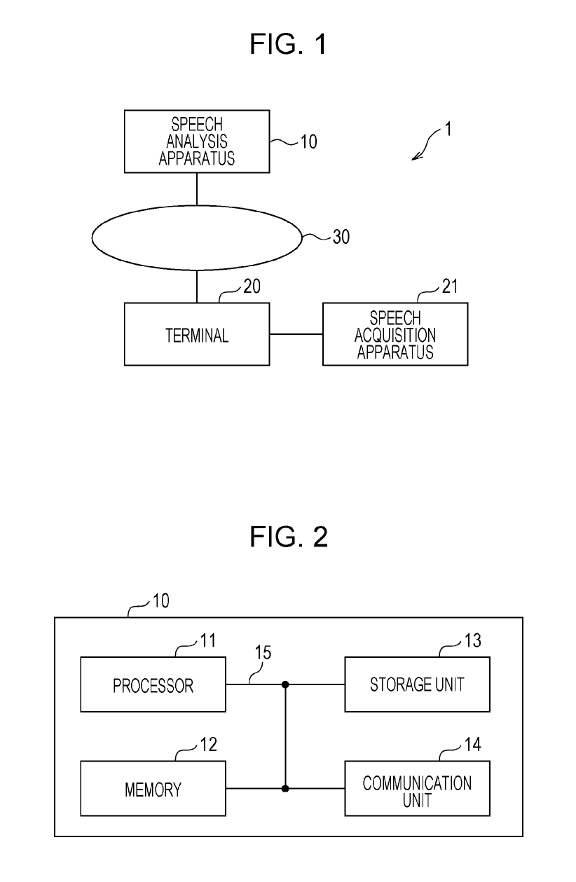

FIG. 1 depicts an example of a configuration of a speech analysis system 1 according to an exemplary embodiment. The speech analysis system 1 is a system that analyzes an utterance received from a terminal 20 and that infers the topic of the utterance. The topic of the utterance indicates the subject matter or a summary of the utterance. The speech analysis system 1 includes a speech analysis apparatus 10 and the terminal 20. In the example depicted in FIG. 1, the speech analysis system 1 includes a single speech analysis apparatus 10 and a single terminal 20 but may include a plurality of speech analysis apparatuses 10 and a plurality of terminals 20. The speech analysis apparatus 10 and the terminal 20 are connected to each other via a communication network 30.

FIG. 2 depicts an example of a hardware configuration of the speech analysis apparatus 10. The speech analysis apparatus 10 is a computer that includes a processor 11, a memory 12, a storage unit 13, and a communication unit 14. These units are connected to each other via a bus 15.

The processor 11 reads a program into the memory 12 and executes the program to perform various kinds of processing. For example, the processor 11 may be constituted by a central processing unit (CPU). The memory 12 stores the program to be executed by the processor 11. For example, the memory 12 may be constituted by a read-only memory (ROM) or a random access memory (RAM). The storage unit 13 stores various kinds of data and the program. For example, the storage unit 13 may be constituted by a hard disk drive or a flash memory. The communication unit 14 is a communication interface connected to the communication network 30. The communication unit 14 performs data communication via the communication network 30.

The terminal 20 is used for an input of an utterance by a user. The terminal 20 is a computer that includes an input acceptance unit (not depicted), a display unit (not depicted), and a speech acquisition apparatus 21 in addition to the same configuration as the configuration of the speech analysis apparatus 10. The input acceptance unit is used for accepting various kinds of information. For example, the input acceptance unit may be constituted by a keyboard, a mouse, a physical button, a touch sensor, or a combination thereof. The display unit displays various kinds of information. For example, the display unit may be constituted by a liquid crystal display. The speech acquisition apparatus 21 acquires an utterance. The speech acquisition apparatus 21, which is, for example, a surround microphone system, captures sounds from left and right and converts the sounds into a two-channel speech signal.

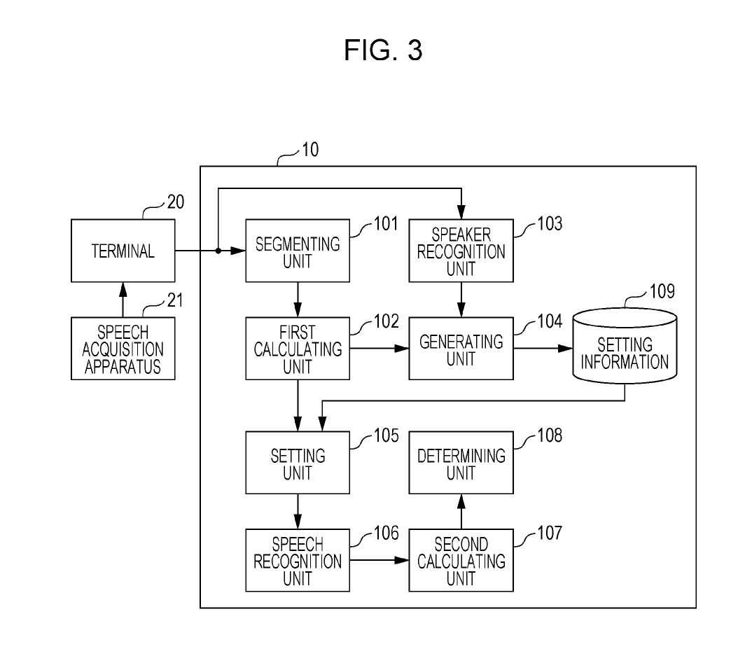

FIG. 3 depicts an example of a functional configuration of the speech analysis apparatus 10. The speech analysis apparatus 10 functions as a segmenting unit 101, a first calculating unit 102, a speaker recognition unit 103, a generating unit 104, a setting unit 105, a speech recognition unit 106, a second calculating unit 107, and a determining unit 108. The program, which is stored in the memory 12, and the processor 11 that executes the program operate in combination with each other, and the processor 11 performs calculation and control of communication via the communication unit 14 to realize these functions.

The segmenting unit 101 segments a speech signal representing an utterance acquired by the speech acquisition apparatus 21 into sections, each of which corresponds to a word. For example, a technique of segmenting an utterance into words (speech segmentation) may be used to segment the speech signal into sections.

The first calculating unit 102 calculates the stress level of each of the sections into which a speech signal is segmented by the segmenting unit 101. The stress level indicates the degree of stress placed on a section. To calculate the stress level, for example, at least one of intensity, duration, and pitch of an utterance may be used. This is because the degree of stress is considered to be higher, for example, as the intensity of an utterance is higher, the duration of a word is longer, or the pitch of an utterance is higher.

The speaker recognition unit 103 uses a speech signal representing an utterance, which is acquired by the speech acquisition apparatus 21, and recognizes a speaker of the utterance. A known technique of speaker recognition, for example, may be used to recognize a speaker.

The generating unit 104 generates a piece of setting information 109 concerning a speaker recognized by the speaker recognition unit 103. The piece of setting information 109 may include, for example, information indicating a feature of the stress level of an utterance by a speaker, such as the upper limit and the lower limit of the stress level.

The setting unit 105 uses the information indicating a feature of the stress level of an utterance by a speaker, such as the upper limit and the lower limit of the stress level, included in the piece of setting information 109 and sets the sections into which a speech signal is segmented by the segmenting unit 101 to a stressed section, an ordinary section, or a vague section. In the present exemplary embodiment, a stressed section and an ordinary section are used as a valid section, and a vague section is used as an invalid section.

The speech recognition unit 106 performs speech recognition on stressed or ordinary sections and recognizes a word corresponding to each of the stressed or ordinary sections. A known technique of speech recognition may be used to recognize a word. On the other hand, the speech recognition unit 106 does not perform speech recognition on a vague section. In other words, the speech recognition unit 106 does not attempt to recognize a word corresponding to a vague section.

The second calculating unit 107 uses a weight, which is predetermined for a word recognized by the speech recognition unit 106 regarding at least one of a plurality of topics, and the stress level of a section to which the word recognized by the speech recognition unit 106 corresponds, the stress level being calculated by the first calculating unit 102, and calculates an index for the at least one of the plurality of topics. The weight for a word is, for example, a value representing the degree of relation to a topic and may be predetermined in accordance with the appearance frequency of the word in the topic. The index for a topic is, for example, a value representing the possibility that the topic is a major topic of an utterance. The index may be calculated, for example, by multiplying the weight of a word and the stress level of the word.

The determining unit 108 identifies a topic of an utterance among a plurality of topics in accordance with indexes calculated by the second calculating unit 107. For example, a topic having the highest index may be identified.

### 2. Operation

### 2.1 Generating Setting Information

A different speaker sometimes has a different reference level for the stress of an utterance. To infer the topic of an utterance accurately even in such a case, the piece of setting information 109 concerning a speaker is generated before processing is performed to infer the topic of an utterance. The piece of setting information 109, which is also referred to as a profile, is a piece of information that indicates settings determined for each speaker.

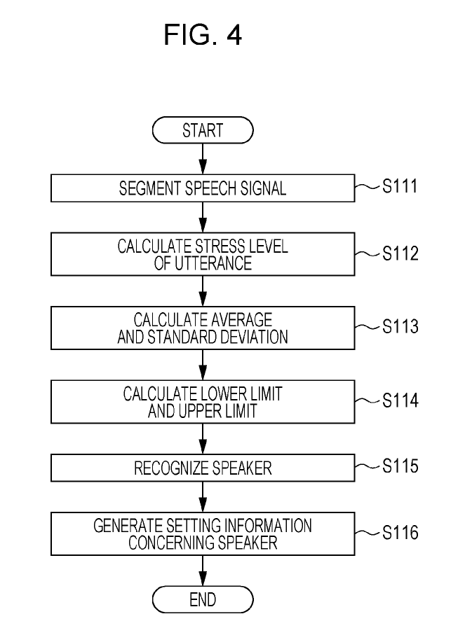

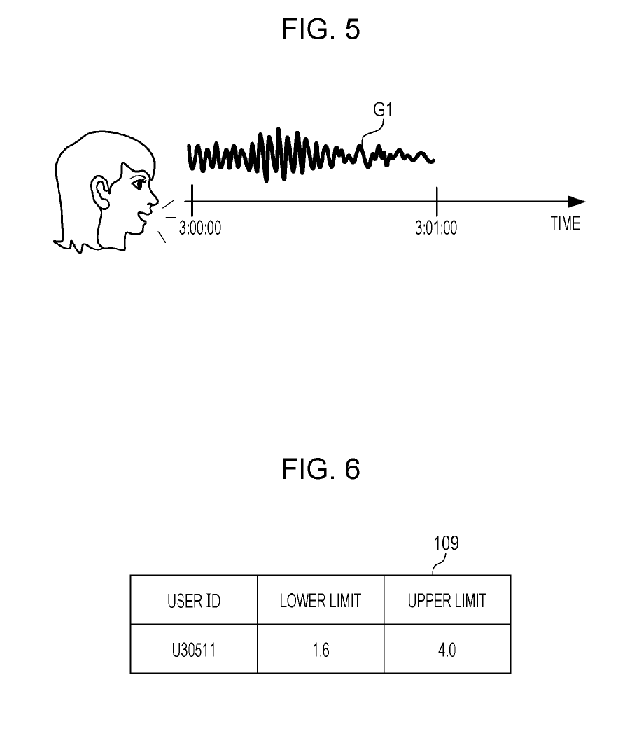

FIG. 4 is a flowchart depicting example processing of generating the piece of setting information 109. A user provides an input of an utterance of their own by using the speech acquisition apparatus 21 to generate the piece of setting information 109. In this case, it is assumed that a user provides an input of an utterance of their own for a minute from 3:00:00 to 3:01:00 as depicted in FIG. 5. For example, the utterance may be a voice in which predetermined sentences are read. When the utterance is input into the speech acquisition apparatus 21, a speech signal G1 representing the utterance is transmitted from the terminal 20 to the speech analysis apparatus 10.

In step S111, when the speech signal G1 is received, the segmenting unit 101 segments the speech signal G1 into a plurality of sections, all of which have equal duration.

In step S112, the first calculating unit 102 calculates the stress level of an utterance for each section by using Equation 1 below. In Equation 1, word_stressᵢ denotes the stress level of an utterance corresponding to the i-th section, where i is a natural number. The start time and the end time of the i-th section are denoted by Wᵢₛₜₐᵣₜ and W_{iend}, respectively. The amplitude of a speech signal in the first channel and the amplitude of a speech signal in the second channel are denoted by X₁(t) and X₂(t), respectively. The pitch of a speech signal in the first channel and the pitch of a speech signal in the second channel are denoted by P₁(t) and P₂(t), respectively. The weight for the intensity of an utterance, the weight for the duration of an utterance, and the weight for the pitch of an utterance are denoted by α, β, and γ, respectively, and these parameters are, for example, zero or larger. For example, when only the intensity of an utterance is used, a may be set to one, and β and γ may be set to zero. The symbol “*” indicates multiplication.

$${word\_stress}_{i} = α * {\int }_{{w}_{{i}_{start}}}^{{w}_{{i}_{end}}} \frac{{X}_{1}^{2} ( t ) + {X}_{2}^{2} ( t )}{2} dt + β * {\int }_{{w}_{{i}_{start}}}^{{w}_{{i}_{end}}} 1 dt + γ * {\int }_{{w}_{{i}_{start}}}^{{w}_{{i}_{end}}} \frac{{P}_{1}^{2} ( t ) + {P}_{2}^{2} ( t )}{2} dt \qquad ( 1 )$$

In step S113, the first calculating unit 102 approximates the distribution of the stress levels of utterances calculated in step S112 as a normal distribution and calculates the average and the standard deviation of the normal distribution.

In step S114, the first calculating unit 102 calculates the lower limit and the upper limit of the stress level of an utterance by using Equation 2 and Equation 3, respectively. The lower limit and the upper limit of the stress level of an utterance are denoted by stressMin in Equation 2 and stressMax in Equation 3, respectively. The average and the standard deviation of the stress levels of utterances are denoted by μ and σ, respectively. In Equations 2 and 3, the coefficient is set to 2, but a natural number other than 2 may be used as the coefficient.

stressMin=μ−2*σ (2)

stressMax=μ+2*σ (3)

In step S115, the speaker recognition unit 103 analyzes the received speech signal G1 and recognizes the speaker. The processing in step S115 may be performed before or at the same time as the processing from step S111 to step S114.

In step S116, the generating unit 104 generates the piece of setting information 109 concerning the speaker in accordance with the lower limit and the upper limit calculated in step S114 and the speaker recognized in step S115.

FIG. 6 illustrates an example of the piece of setting information 109. The piece of setting information 109 includes a user identifier (ID) to identify the speaker recognized in step S115 in association with the lower limit and the upper limit calculated in step S114. The user ID may be acquired, for example, from a managing apparatus that manages the user IDs.

The piece of setting information 109 concerning each speaker is generated in this manner. The generated pieces of setting information 109 may be stored, for example, in the storage unit 13.

### 2.2 Topic Inference Processing

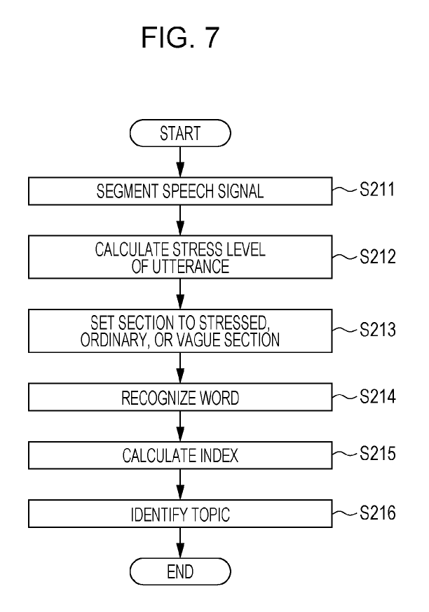

Next, processing for inferring the topic of an utterance from the utterance by a speaker will be described. FIG. 7 is a flowchart depicting an example of topic inference processing. A speaker provides an input of an utterance of their own by using the speech acquisition apparatus 21 after the piece of setting information 109 is generated. In this case, it is assumed that a speaker whose user ID is “U30511” starts to provide an input of an utterance at the time point 3:01:00. When the utterance is input into the speech acquisition apparatus 21, a speech signal G2 representing the utterance is transmitted from the terminal 20 to the speech analysis apparatus 10.

In step S211, when the speech signal G2 is received, the segmenting unit 101 segments the speech signal G2 into a plurality of sections, each of which corresponds to a word.

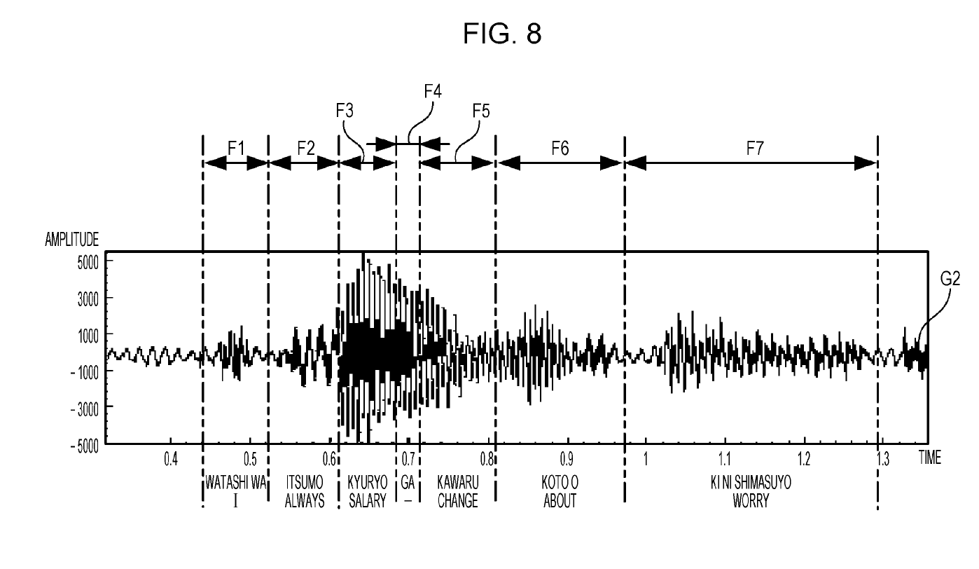

FIG. 8 illustrates an example of the speech signal G2. In the example illustrated in FIG. 8, the speech signal G2 is segmented into section F1 to section F7. Each of section F1 to section F7 contains a single word.

In step S212, the first calculating unit 102 calculates the stress level of an utterance for each section. The first calculating unit 102 uses at least one of the intensity of an utterance, the duration of a word, and the pitch of an utterance and calculates the stress level.

The intensity of an utterance is calculated by using Equation 4 below. In Equation 4, stressWeight_intensity denotes the intensity of an utterance. The start time and the end time of a section are denoted by Wₛₜₐᵣₜ and W_{end}, respectively. The amplitude of a speech signal in the first channel and the amplitude of a speech signal in the second channel are denoted by X₁(t) and X₂(t), respectively.

$$stressWeight\_intensity = {\int }_{{w}_{start}}^{{w}_{end}} \frac{{X}_{1}^{2} ( t ) + {X}_{2}^{2} ( t )}{2} dt \qquad ( 4 )$$

The duration of a word is calculated by using Equation 5 below. In Equation 5, stressWeight_duration denotes the duration of a word. The start time and the end time of the section are denoted by Wₛₜₐᵣₜ and W_{end}, respectively.

stressWeight_duration=wₛₜₐᵣₜ−w_{end} (5)

The pitch of an utterance is calculated by using Equation 6 below. In Equation 6, stressWeight_pitch denotes the pitch of an utterance. The pitch of a speech signal in the first channel and the pitch of a speech signal in the second channel are denoted by P₁(t) and P₂(t), respectively.

$$stressWeight\_pitch = {\int }_{{w}_{start}}^{{w}_{end}} \frac{{P}_{1}^{2} ( t ) + {P}_{2}^{2} ( t )}{2} dt \qquad ( 6 )$$

The stress level of an utterance is calculated by using Equation 7 below. In Equation 7, stressWeight_all denotes the stress level of an utterance calculated by using at least one of the intensity of the utterance, the duration of the word, and the pitch of the utterance. The weight for the intensity of the utterance, the weight for the duration of the word, and the weight for the pitch of the utterance are denoted by α, β, and γ, respectively, and these parameters are, for example, zero or larger. For example, when only the intensity of the utterance is used, α may be set to one, and β and γ may be set to zero.

stressWeight_all=α*stressWeight_intensity+β*stressWeight_duration+γ*stressWeight_pitch (7)

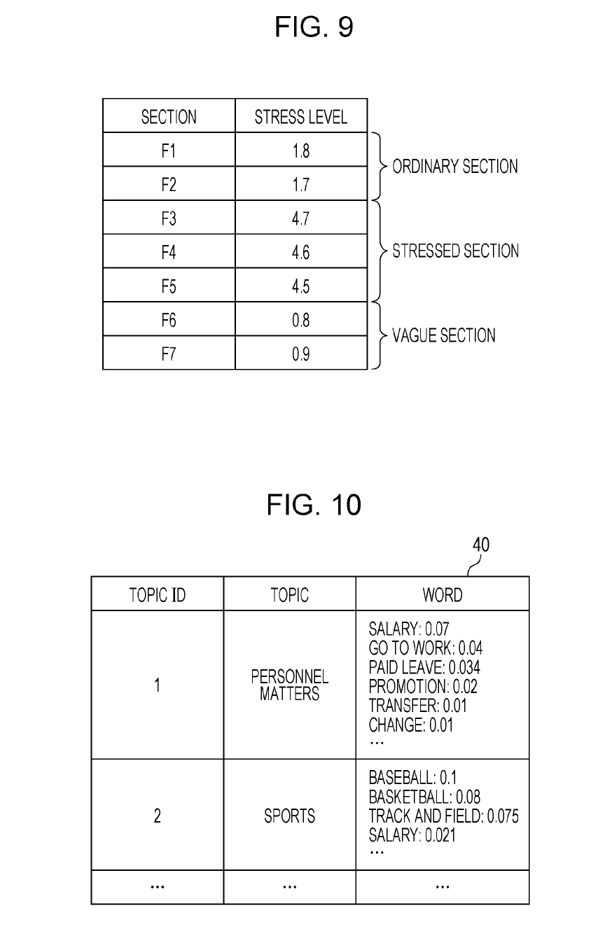

FIG. 9 illustrates an example of stress levels from section F1 to section F7. In the example illustrated in FIG. 9, the stress levels from section F1 to section F7 are 1.8, 1.7, 4.7, 4.6, 4.5, 0.8, and 0.9.

In step S213, the setting unit 105 sets the sections to a stressed section, an ordinary section, or a vague section in accordance with the stress levels calculated in step S212 and the piece of setting information 109 concerning the speaker. For example, when the stress level of a section is higher than the upper limit included in the piece of setting information 109, this section is set to a stressed section. When the stress level of a section is lower than the lower limit included in the piece of setting information 109, this section is set to a vague section. When the stress level of a section is equal to or higher than the lower limit included in the piece of setting information 109 and equal to or lower than the upper limit included in the piece of setting information 109, this section is set to an ordinary section.

In the example illustrated in FIG. 6, the lower limit of the stress level of an utterance by the speaker whose user ID is “U30511” is 1.6, and the upper limit is 4.0. In the example illustrated in FIG. 9, sections F3 to F5 all have a stress level higher than the upper limit, which is equal to 4.0, and thus each of these sections is set to a stressed section. Sections F6 and F7 both have a stress level lower than the lower limit, which is equal to 1.6, and thus each of these sections is set to a vague section. Sections F1 and F2 both have a stress level equal to or higher than the lower limit, which is equal to 1.6, and equal to or lower than the upper limit, which is equal to 4.0, and thus each of these sections is set to an ordinary section.

In step S214, the speech recognition unit 106 performs speech recognition on the sections set to a stressed section or to an ordinary section in step S213 and recognizes a word corresponding to each of the sections. In the example illustrated in FIG. 9, sections F1 to F5 are set to a stressed section or to an ordinary section. Thus, as illustrated in FIG. 8, the words that correspond to these sections F1 to F5 are recognized. The recognized Japanese words are (English translations in parentheses) “WATASHI WA” (I), “ITSUMO” (ALWAYS), “KYURYO” (SALARY), “GA” (no counterpart), and “KAWARU” (CHANGE). The speech recognition unit 106 does not attempt to recognize a word corresponding to a section set to a vague section in step S213. In the example illustrated in FIG. 9, sections F6 and F7 are set to a vague section, and thus speech recognition is not performed on these sections F6 and F7.

In step S215, the second calculating unit 107 refers to a relation table 40 and calculates an index for each of a plurality of topics by using Equation 8 below. The index for a topic represents the possibility that the topic is a major topic of the utterance. In Equation 8, S(Tᵢ) denotes the index for the i-th topic. The weight of the j-th word regarding the i-th topic is denoted by topic_wordᵢⱼ. The stress level of the j-th word is denoted by word_stressⱼ. The number of words relating to the i-th topic is denoted by Mᵢ.

S(Tᵢ)=Σⱼ₌₁^{M}^{ᵢ}topic_wordᵢⱼ*word_stressⱼ) (8)

FIG. 10 illustrates an example of the relation table 40. For various kinds of topics, the relation table 40 contains words relating to each of the various kinds of topics and pieces of data, each of which indicates the weight of one of the words regarding each of the various kinds of topics. The relation table 40 may be stored, for example, in an external apparatus connected to the communication network 30. In such a case, the relation table 40 may be used by accessing the external apparatus via the communication network 30 or may be downloaded from the external apparatus and used.

In the relation table 40, a topic ID to identify a topic, contents of the topic, and the weights of words regarding the topic are associated with each other. For example, a topic “PERSONNEL MATTERS” is associated with a word “SALARY”, and the weight of the word “SALARY” regarding the topic “PERSONNEL MATTERS” is 0.07. This association indicates that the word “SALARY” relates to the topic “PERSONNEL MATTERS”, and the relation of “SALARY” to “PERSONNEL MATTERS” is closer than the relations of other words. A topic “SPORTS” is also associated with the word “SALARY”, and the weight of the word “SALARY” regarding the topic “SPORTS” is 0.021. This association indicates that the word “SALARY” relates to the topic “SPORTS”, but the relation of “SALARY” to “SPORTS” is not as close as the relations of other words. In this manner, a single word may relate to a plurality of topics. In addition, a single word may have a different weight regarding a different topic.

In the example illustrated in FIGS. 8 and 10, of the words recognized in step S214, words that relate to the topic “PERSONNEL MATTERS” are “KYURYO” or “SALARY” and “KAWARU” or “CHANGE”. Regarding the topic “PERSONNEL MATTERS”, the weight of the word “SALARY” is 0.07, and the weight of the word “CHANGE” is 0.01. Further, in the example illustrated in FIG. 9, the stress level of section F3 corresponding to the word “SALARY” is 4.7, and the stress level of section F5 corresponding to the word “CHANGE” is 4.5. In this case, the index for the topic “PERSONNEL MATTERS” is calculated as 4.7*0.07+4.5 0.01=0.374.

Further, in the example illustrated in FIGS. 8 and 10, of the words recognized in step S214, a word that relates to the topic “SPORTS” is “KYURYO” or “SALARY”. Regarding the topic “SPORTS”, the weight of the word “SALARY” is 0.021. In the example illustrated in FIG. 9, the stress level of section F3 corresponding to the word “SALARY” is 4.7. In this case, the index for the topic “SPORTS” is calculated as 4.7*0.021=0.0987. In this manner, indexes are calculated for various topics included in the relation table 40.

In step S216, the determining unit 108 identifies as the topic of the utterance a topic having the highest index among the indexes calculated in step S215. For example, if the topic “PERSONNEL MATTERS” has the highest index, the topic “PERSONNEL MATTERS” is identified. The topic identified in this manner may be output. For example, topic information indicating the identified topic may be transmitted to the terminal 20 and may be displayed on the display unit of the terminal 20.

### 3. Modification

The exemplary embodiment described above is an example of the present disclosure. The present disclosure is not limited to the exemplary embodiment described above. For example, the exemplary embodiment described above may be modified as described below. In addition, two or more modifications described below may be combined and executed.

In the exemplary embodiment described above, only the topic having the highest index is identified, but a plurality of topics having indexes higher than a predetermined value may be identified. In such a case, each of the plurality of topics may be output in a different format.

The topic inference processing described above in the exemplary embodiment may be performed after the speaker finishes speaking or may be performed in real time while the speaker is speaking. In addition, the topic inference processing may be performed at every predetermined break of an utterance. The break may be placed after a sentence or a paragraph. Alternatively, the breaks may be placed at predetermined time points. In such a case, pieces of topic information may be displayed chronologically.

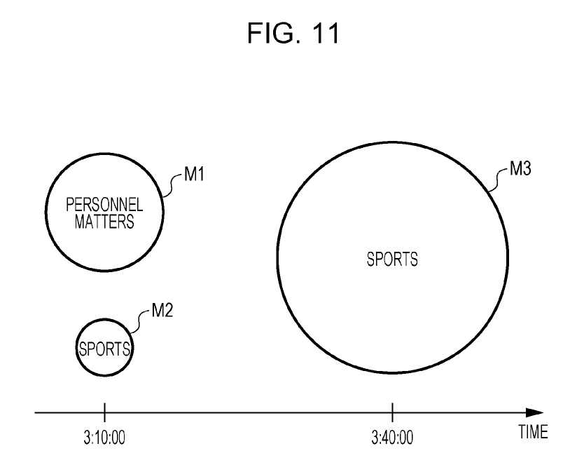

FIG. 11 illustrates an example presentation of topic information. In the example illustrated in FIG. 11, an image M1 named as “PERSONNEL MATTERS” and an image M2 named as “SPORTS” are displayed in a region corresponding to 3:10:00. In addition, an image M3 named as “SPORTS” is displayed in a region corresponding to 3:40:00. Each of the images M1, M2, and M3 has a size based on the index, and the size increases as the index increases. The example illustrated in FIG. 11 indicates that a topic relating to personnel matters and a topic relating to sports have been discussed from 3:10:00 to 3:40:00 with personnel matters being a major topic and sports being a secondary topic and sports have been discussed as a major topic since 3:40:00. According to this modification, a transition between topics and a weight of a topic may be easily recognized.

In the exemplary embodiment described above, the stress level of an utterance is calculated by using at least one of the intensity of an utterance, the duration of a word, and the pitch of an utterance, but the method for calculating the stress level of an utterance is not limited to the method in the exemplary embodiment. Other methods may be used to calculate the stress level of an utterance as long as the degree of stress of an utterance is represented.

In the exemplary embodiment described above, speech recognition is not performed on a section set to a vague section, but speech recognition may be performed on such a section. For example, speech recognition may be performed only on a portion of a vague section.

When the setting information 109 is generated in the exemplary embodiment described above, an utterance may also be segmented by using a speech segmentation technique into a plurality of sections, each of which corresponds to a word.

Processing steps performed by the speech analysis system 1 or by the speech analysis apparatus 10 are not limited to the example described above in the exemplary embodiment. The processing steps may be interchanged with each other as long as no contradiction occurs. The present disclosure may be provided as a speech analysis method including processing steps performed by the speech analysis system 1 or by the speech analysis apparatus 10.

The present disclosure may be provided as a non-transitory computer readable medium storing a program executed by the speech analysis apparatus 10. The program may be downloaded via a communication network, such as the Internet, or may be stored in a computer readable recording medium, such as a magnetic recording medium (a magnetic tape, a magnetic disk, or the like), an optical recording medium (an optical disc or the like), a magneto-optical recording medium, or a semiconductor memory and then provided.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A speech analysis apparatus that operates in combination with a speech acquisition apparatus, the speech analysis apparatus comprising:
a segmenting unit that segments a speech signal representing an utterance acquired by the speech acquisition apparatus into sections, each of the sections corresponding to a word;
a first calculating unit that calculates a stress level of each of the sections into which the speech signal is segmented by the segmenting unit;
a speech recognition unit that performs speech recognition and recognizes a word corresponding to each of the sections that have been subjected to the speech recognition;
a second calculating unit that uses a weight, the weight being predetermined for each of the words recognized by the speech recognition unit regarding at least one of a plurality of topics, and the stress level of a section to which each of the words recognized by the speech recognition unit corresponds, the stress level being calculated by the first calculating unit, and that calculates an index for the at least one of the plurality of topics; and
a determining unit that identifies a topic of the utterance among the plurality of topics in accordance with the indexes calculated by the second calculating unit.

2. The speech analysis apparatus according to claim 1,
wherein the second calculating unit calculates the index by multiplying the weight and the stress level with each other.

3. The speech analysis apparatus according to claim 1, further comprising:
a setting unit that sets the section to a valid section or an invalid section in accordance with the stress level calculated by the first calculating unit,
wherein the speech recognition unit performs the speech recognition on a section set to the valid section and recognizes a word corresponding to the section.

4. The speech analysis apparatus according to claim 2, further comprising:
a setting unit that sets the section to a valid section or an invalid section in accordance with the stress level calculated by the first calculating unit,
wherein the speech recognition unit performs the speech recognition on a section set to the valid section and recognizes a word corresponding to the section.

5. The speech analysis apparatus according to claim 3,
wherein the first calculating unit uses another speech signal representing another utterance acquired from a speaker of the utterance by the speech acquisition apparatus and calculates a lower limit of a stress level of the other utterance, and
the setting unit sets the section to the valid section if the stress level calculated by the first calculating unit is equal to or higher than the lower limit.

6. The speech analysis apparatus according to claim 4,
wherein the first calculating unit uses another speech signal representing another utterance acquired from a speaker of the utterance by the speech acquisition apparatus and calculates a lower limit of a stress level of the other utterance, and
the setting unit sets the section to the valid section if the stress level calculated by the first calculating unit is equal to or higher than the lower limit.

7. The speech analysis apparatus according to claim 1, further comprising:
a setting unit that sets the section to a valid section or an invalid section in accordance with the stress level calculated by the first calculating unit,
wherein the speech recognition unit does not perform the speech recognition on a section set to the invalid section.

8. The speech analysis apparatus according to claim 2, further comprising:
a setting unit that sets the section to a valid section or an invalid section in accordance with the stress level calculated by the first calculating unit,
wherein the speech recognition unit does not perform the speech recognition on a section set to the invalid section.

9. The speech analysis apparatus according to claim 7,
wherein the first calculating unit uses another speech signal representing another utterance acquired from a speaker of the utterance by the speech acquisition apparatus and calculates a lower limit of a stress level of the other utterance, and
the setting unit sets the section to the invalid section if the stress level calculated by the first calculating unit is lower than the lower limit.

10. The speech analysis apparatus according to claim 8,
wherein the first calculating unit uses another speech signal representing another utterance acquired from a speaker of the utterance by the speech acquisition apparatus and calculates a lower limit of a stress level of the other utterance, and
the setting unit sets the section to the invalid section if the stress level calculated by the first calculating unit is lower than the lower limit.

11. The speech analysis apparatus according to claim 1,
wherein the first calculating unit uses at least one of an intensity of an utterance corresponding to the section, duration of an utterance corresponding to the section, and pitch of an utterance corresponding to the section and calculates the stress level.

12. A speech analysis system comprising:
a speech acquisition apparatus that acquires an utterance; and
a speech analysis apparatus,
wherein the speech analysis apparatus includes
a segmenting unit that segments a speech signal representing the utterance acquired by the speech acquisition apparatus into sections, each of the sections corresponding to a word,
a first calculating unit that calculates a stress level of each of the sections into which the speech signal is segmented by the segmenting unit,
a speech recognition unit that performs speech recognition and recognizes a word corresponding to each of the sections that have been subjected to the speech recognition,
a second calculating unit that uses a weight, the weight being predetermined for each of the words recognized by the speech recognition unit regarding at least one of a plurality of topics, and the stress level of a section to which each of the words recognized by the speech recognition unit corresponds, the stress level being calculated by the first calculating unit, and that calculates an index for the at least one of the plurality of topics, and
a determining unit that identifies a topic of the utterance among the plurality of topics in accordance with the indexes calculated by the second calculating unit.

13. A non-transitory computer readable medium storing a program causing a computer to execute a process for information processing in combination with a speech acquisition apparatus, the process comprising:
segmenting a speech signal representing an utterance acquired by the speech acquisition apparatus into sections, each of the sections corresponding to a word;
calculating a stress level of each of the sections into which the speech signal is segmented;
performing speech recognition and recognizing a word corresponding to each of the sections that have been subjected to the speech recognition;
using a weight, the weight being predetermined for each of the recognized words regarding at least one of a plurality of topics, and the calculated stress level of a section to which each of the recognized words corresponds and calculating an index for the at least one of the plurality of topics; and
identifying a topic of the utterance among the plurality of topics in accordance with the calculated indexes.
